(19) United States
(12) Patent Application Publication
(10) Pub. No.: US 2011/0170145 A1
(43) Pub. Date: Jul. 14, 2011

(54) Secure Document Creation with a Multi-Function Apparatus

(75) Inventors: Alexander Govyadinov, Corvallis, OR (US); Tommy D. Deskins, Albany, OR (US); Ellen L. Chappell, Corvallis, OR (US); Steven J. Simske, Fort Collins, CO (US)

(73) Assignee: Hewlett-Packard Development Company, Houston, TX (US)

(21) Appl. No.: 13/062,492

(22) PCT Filed: Oct. 2, 2008
(86) PCT No.: PCT/US08/78590

§ 371 Date: Mar. 4, 2011

(51) Int. Cl. H04N 1/40

(52) U.S. Cl. 358/3.28

(57) ABSTRACT

In a method of creating a secure document with a multi-function apparatus, identity information of a user is obtained. The identity information is converted into a security feature, which is created to enable the user's identity information to be retrievable directly from the security feature. In addition, the security feature is printed onto the document with the multi-function apparatus.

### BACKGROUND

Printed documents, particularly documents containing sensitive, or otherwise important information, are often subject to fraud, counterfeiting, and other tampering. One attempt at combating this problem has been through application of watermarks on the printed documents. The watermarks are physical designs embossed or pressed into the document that can be seen when the document is held up to a light. Visible watermarks are typically faint background images superimposed on the document. Invisible watermarks are typically patternless arrangements of bits hidden in the document.

With the increased sophistication in today's scanners and printers, which are capable of recreating many of the visible and invisible watermarks, the use of conventional watermarks is typically insufficient to prevent the documents from succumbing to fraud, counterfeiting, or other tampering.

It would therefore be beneficial to be able to securely protect documents in a manner that further deters fraud, counterfeiting, or other tampering on the documents.

### BRIEF DESCRIPTION OF THE DRAWINGS

Features of the present invention will become apparent to those skilled in the art from the following description with reference to the figures, in which:

FIG. 1 shows a block diagram of a multi-function apparatus, according to an embodiment of the invention;

FIG. 2A shows a flow diagram of a method of creating a secure document with a multi-function apparatus, according to an embodiment of the invention;

FIG. 2B shows a flow diagram of a method of determining whether a user is authorized a document prior to performing some of the steps outlined in FIG. 2A, according to an embodiment of the invention;

FIG. 3 shows a flow diagram of a method of verifying an authenticity of a secure document with a multi-function apparatus, according to an embodiment of the invention; and

FIG. 4 illustrates a computer system, which may be employed to perform various functions of the multi-function apparatus depicted in FIG. 1, according to an embodiment of the invention.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a multi-function apparatus, a method of implementing the-multi-function apparatus to create a secure document, and a computer readable storage medium on which is embedded one or more computer programs implementing the method. As described in greater detail herein below, the multi-function apparatus is employed to create a secure document by converting a user's identity information into a security feature and by printing the security feature onto the document. According to an example, the multi-function apparatus prints the security feature using a nearly invisible material to further prevent copying of and tampering with the security feature.

According to another example, the multi-function apparatus is configured to receive a user's biometric information and to convert the user's biometric information into the security feature. In this example, another user wishing to verify the authenticity of the secure document uses a suitably equipped multi-function apparatus, for instance, the multi-function apparatus disclosed herein, to obtain the first user's biometric information, which the multi-function apparatus uses to compare with the security feature.

According to a further example, the multi-function apparatus prints at least one relevant item of information contained in the content of the document as a security feature. More particularly, for instance, the multi-function apparatus prints the at least one relevant information using the nearly invisible material. This increases the security level of the secure document because both the content and the security feature would need to be altered in order to alter the document contents without raising suspicion.

Through implementation of the multi-function apparatus and method disclosed herein, a secure all-in-one multi-function apparatus may be employed to create secure documents that are difficult to fraudulently copy, counterfeit, or otherwise become tampered.

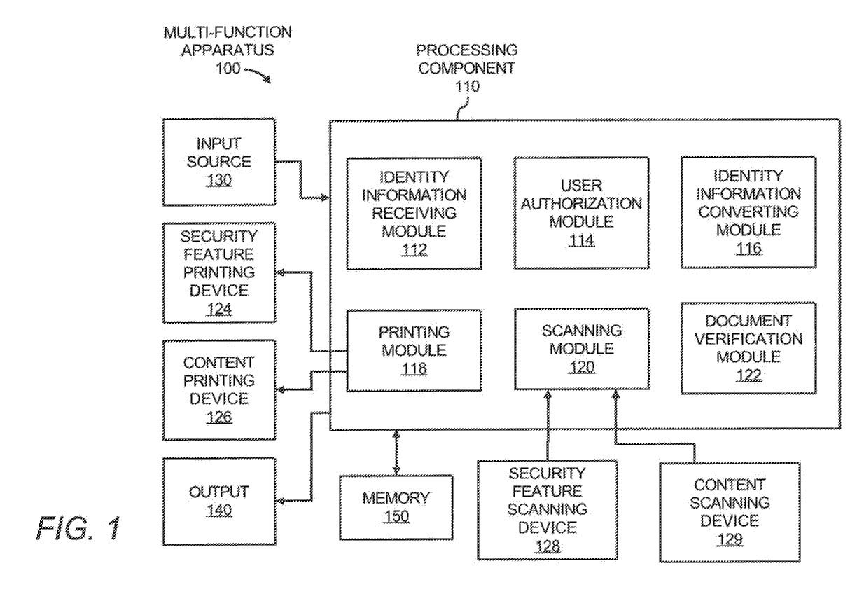

With reference first to FIG. 1, there is shown a block diagram of a multi-function apparatus 100, according to an example. It should be understood that the multi-function apparatus 100 may include additional components and that some of the components described herein may be removed and/or modified without departing from a scope of the multi-function apparatus 100.

As the name suggests, the multi-function apparatus 100 is configured to perform multiple functions, which may include, for instance, scanning of documents, printing of documents, printing of security features, receipt of one or more forms of user identification information, verification of document authenticity, etc. A user may employ one or more of these functions to access and create a secure document with the multi-function apparatus 100. In addition, the authenticity of the secure document may be verified through the use of the multi-function apparatus 100 or another similarly configured multi-function apparatus. Both of these features are described in greater detail herein below.

As shown in FIG. 1, the multi-function apparatus 100 includes a processing component 110, an input source 130, an output 140, and a memory 150. The processing component 110 comprises a plurality of modules 112-122 that are configured to perform various functions in one or both of creating secure documents and verifying the authenticity of documents created through implementation of the multi-function apparatus 100 or another similarly configured multi-function apparatus.

According to an example, the processing component 110 comprises a hardware device, such as, a circuit or multiple circuits arranged on a board. In this example, the modules 112-122 comprise circuit components or individual circuits. According to another example, the processing component 110 comprises software stored, for instance, in a volatile or non-volatile memory, such as DRAM, EEPROM, MRAM, flash memory, floppy disk, a CD-ROM, a DVD-ROM, or other optical or magnetic media, and the like. In this example, the modules 112-122 comprise software modules stored in the memory. According to a further example, the processing component 110 may comprise a combination of hardware and software modules. In any of the examples above, the processing component 110 may be implemented or invoked by a controller (not shown), such as, a microprocessor, a micro-controller, an application specific integrated circuit (ASIC), and the like, configured to perform various processing functions.

Initially, the multi-function apparatus 100 may be employed as a security device to substantially prevent access to documents stored locally on the multi-function apparatus 100 and/or remotely from the multi-function apparatus 100 by unauthorized personnel. More particularly, the multi-function apparatus 100 may be configured to receive identity information from a user and to compare the identity information with stored information in order to determine whether the user is allowed access to the documents.

By way of particular example, the input source 130 may comprise one or more interface devices through which the user may enter his or her credentials into the multi-function apparatus. The input source 130 may thus comprise a keypad through which the user may enter a passcode, a reader device configured to obtain data from an authorizing item in the user's possession (such as, a smart card, a radio frequency identification card, a dongle, a Wiegand, a card having a magnetic stripe, etc.), a biometric entry device configured to obtain biometric information of the user (such as, voice, fingerprint, facial image, eye information, etc.), and the like.

In this example, the identity information receiving module 112 receives the user's identity information from the input source 130. In addition, the user authorization module 114 compares the received user's identity information with identity information stored locally on the multi-function apparatus 100 and/or remotely from the multi-function apparatus 100. The user authorization module 114 employs one or more comparisons based upon the types and numbers of interface devices used to receive the user identity information.

The user authorization module 114 allows the user to access a particular document if the user authorization module 114 determines that the user is authorized to access that document based upon the user's credentials. In this instance, the user accesses the document and, in certain cases, may modify the document contents.

In addition, if the user is authorized to access the document, the identity information converting module 116 converts at least one aspect of the user's identity information into a security feature. The security feature generally comprises a symbol or other indicia that may be deciphered to enable authentication of the document. In other words, the identity information converting module 116 is configured to generate a security feature based upon the user's identity information, such that, the security feature may be read to accurately identify the user's identity information. In addition, the identity information converting module 116 may generate the security feature such that the information contained in the security feature pertaining to the user's identity information is not readily discernable to the naked eye. In this regard, for instance, the identity information converting module 116 is configured to convert the user's identity information into a computer-readable form, such as, a barcode, a Color Code, a glyph, etc.

By way of example, the identity information converting module 116 creates the security feature to include representations of the user's biometric information. More particularly, for instance, if the user provided a fingerprint sample to the multi-function apparatus 100, the identity information converting module 116 is configured to include a data representation of the fingerprint sample in the security feature, for instance, data indicating various locations of features in the fingerprint sample. As another example, if the user provided a voice sample to the multi-function apparatus 100, the identity information converting module 116 is configured to include a data representation of the user's voice sample, such as, a cepstral representation of the user's speech.

As a further example, instead of biometric data, the user may supply a passcode or other sequentially inserted data into the multi-function apparatus 100, which the identity information converting module 116 may convert or otherwise incorporate into the security feature.

In any regard, the identity information converting module 116 may further prevent accessibility to the security feature, for instance, by encrypting or otherwise modifying the data contained in the security feature. In this instance, another multi-function apparatus 100 may be programmed or otherwise be able to receive programming, for example, from a networked server, to decrypt or decipher the security feature, as described in greater detail herein below.

The printing module 118 is configured to control the printing of the security feature onto the document. According to an example, the printing module 118 controls a security feature printing device 124 to print the security feature onto the document. The security feature printing device 124 may include, for instance, one or more inkjet printheads connected to or having a reservoir containing ink. The ink contained in the reservoir may comprise an ink that is invisible or nearly invisible to the naked eye. The ink may comprise, for instance, UV fluorescent ink, or other photoactive materials, such as, fluorescent dyes, IR dyes, nano-phosphors, carbon nano-tubes, quantum dots, etc. As such, the security feature may be printed using the invisible inks as a further precaution against unauthorized access and/or modification to a document that is to be secured.

According to a further example, the printing module 118 is configured to control the security feature printing device 124 to print other information onto the document, for instance, using the invisible ink. In this example, the printing module 118 may implement the security feature printing device 124 to print at least one relevant item of information on the document using the invisible ink. The at least one relevant item of information may comprise, for instance, important information contained in the document, such as, monetary amounts, dates, or other information. In other words, the relevant information may comprise that information on the document which the user wants to protect from unauthorized modification.

The printing module 118 may also control the printing of other content onto the document through control over a content printing device 126. The content printing device 126 may also comprise one or more inkjet printheads, laser printing components, etc., configured to apply printing materials onto a document to thereby print information, such as, text, figures, etc., onto the document. The content printing device 126 may include multiple colored printing materials to enable printing of multiple colors onto the document.

In addition to adding security features onto documents, the multi-function apparatus 100 may also be configured to identify and read the security features on the documents. In this regard, the multi-function apparatus 100 may be equipped with a security feature scanning device 128 configured, for instance, with a UV lamp to enable detection and scanning of the invisible UV fluorescent ink, or other photoactive materials used to print the security feature. The security feature scanning device 128 may also be employed to scan images of at least one relevant item of information that has been printed on the document using the invisible UV fluorescent ink, or other photoactive materials.

In any event, the scanning module 120 is configured to receive the images scanned by the security feature scanning device 128. In addition, the identity information converting module 116 is configured to convert or otherwise decipher the scanned image of the security feature to retrieve the user identity information contained therein.

The document verification module 122 is configured to verify the authenticity of the document based upon a comparison of user identity information received from the user and the user identity information retrieved from the security feature. As such, when the multi-function apparatus 100 is employed to verify the authenticity of a document, the user again provides identity information through the input source 130. The identity information provided for authentication may be identical to the identity information provided to create the security feature.

The multi-function apparatus 100 is also depicted as including a content scanning device 129 configured with visible lamps to enable the scanning of visible images printed on documents. The scanning module 120 is configured to receive the images captured by the content scanning device and the document verification module 122 may compare content contained in the scanned visible images with the content contained in the scanned invisible images. More particularly, for instance, the document verification module 122 may compare images of the relevant images printed in both the visible and invisible inks to determine whether there are differences between those images. If there are differences between the images, the document verification module 122 may output an indication that the document is inauthentic or that the document has been modified.

Alternatively, the document verification module 122 may display both of the images containing the invisible and visible scans on the output 140 to enable a user to determine whether differences exist in the images. In this instance, the user may manually determine whether the document has been modified.

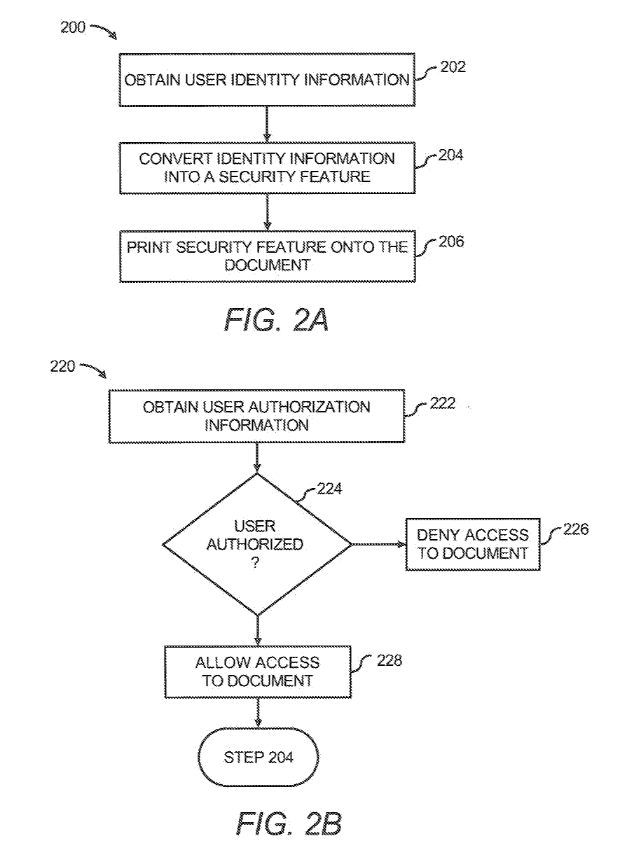

With reference now to FIG. 2A, there is shown a flow diagram of a method 200 of creating a secure document with a multi-function apparatus, according to an example. It should be apparent to those of ordinary skill in the art that the method 200 represents a generalized illustration and that other steps may be added or existing steps may be removed, modified or rearranged without departing from a scope of the method 200.

The description of the method 200 is made with reference to the multi-function apparatus 100 illustrated in FIG. 1, and thus makes reference to the elements cited therein. It should, however, be understood that the method 200 is not limited to the elements set forth in the multi-function apparatus 100 depicted in FIG. 1. Instead, it should be understood that the method 200 may be practiced through use of a multi-function apparatus having a different configuration than that depicted in FIG. 1.

At step 202, a user's identity information is obtained. As discussed above, the user's identity information may be obtained through an input source 130, which may include, for instance, an interface device through which the user may enter his or her credentials. The user's identity information may thus comprise a passcode, alphabetic, numeric, alphanumeric, symbols, etc., that the user may manually enter or may enter through electronic means, such as, through use of a smart card, a radio frequency identification card, a dongle, a Wiegand, a card having a magnetic stripe, etc. The user's identity information may also comprise biometric information of the user, such as, voice, fingerprint, facial image, eye information, etc.

At step 204, at least one of the user's identity information is converted into a security feature. More particularly, the identity information converting module 116 is configured to convert the user's identity information into a security feature by converting the user's identity information from one form to another form, such as, a symbol or other indicia that may be converted back to enable identification of the user's identity information. According to an example, the user's passcode may be encrypted or otherwise modified and may be converted into a barcode. In this example, the information contained in the barcode may be deciphered and decrypted to determine the user's identity information.

According to another example, the user's biometric information may be converted into a barcode or other machine-readable security feature. In this example, the converted form of the user's biometric information may also be encrypted or otherwise modified to further prevent tampering of the security feature.

At step 206, the printing module 118 prints the security feature onto the document. According to a first example, the printing module 118 employs the security feature printing device 124 to print the security feature using ink that is nearly invisible to the naked eye, such as, photoluminescent inks, fluorescent inks, infrared visible inks, etc. According to a second example, the printing module 118 employs the security feature printing device 124 to print the security feature using visible ink.

The identity information converting module 116 may further communicate information pertaining to the converted security feature to a server (not shown), which may be accessible through a network, such as, the Internet. The identity information converting module 116 may encrypt the information pertaining to the converted security feature prior to communicating the information to the server. The information pertaining to the converted security feature may comprise, for instance, a key to enable decryption of the security feature, instructions on how to identify the security feature, etc. As discussed below, a multi-function apparatus 100 may access the server to receive the information and thus be capable of reading and/or deciphering the security feature printed on the document.

Although not shown in FIG. 2A, the printing module 118 may print additional security features onto the document. In this example, at step 204, the identity information converting module 116 may convert at least one relevant item of information to be printed on or located on the document into a security feature. In addition, the printing module 118 may print the additional security feature on the document using either or both of the nearly invisible or visible inks. The additional security feature may include, for instance, important information printed on the document that a user may wish to protect from alteration, such as, important monetary values, important dates, names, etc. By printing the at least one relevant item of information as an additional security feature, tampering of the document contents may further be deterred.

In addition to printing the security feature(s) onto the document, the printing module 118 may also implement the content printing device 126 to print the content of the document.

Prior to allowing the user access to a particular document, the multi-function apparatus 100 may perform an authentication operation to verify that the user is authorized to access the document, as shown in FIG. 2B. More particularly, FIG. 2B shows a flow diagram of a method 220 of determining whether the user is authorized to access the document prior to performing steps 204 and 206 in FIG. 2A.

At step 222, the identity information receiving module 112 receives user authorization information. Step 222 is similar to step 202, in that user identity information is obtained to authorize the user. At step 224, the user authorization module 114 determines whether the user is authorized to access the document. The user authorization module 114 may make this determination by comparing the user's authorization information with information stored in a database. For instance, the user authorization module 114 may determine that the user is authorized to access the document if the information contained in the user authorization information matches the information contained in the database.

If the user authorization module 114 determines that the user is not authorized to access the document, for instance, the user authorization information does not match the information contained in the database, and the user authorization module 114 may deny access to the document, as indicated at step 226. If, however, the user authorization module 114 determines that the user is authorized to access the document, the user authorization module 114 may allow access to the document, as indicated at step 228, and the method 200 (FIG. 2A) may continue at step 204.

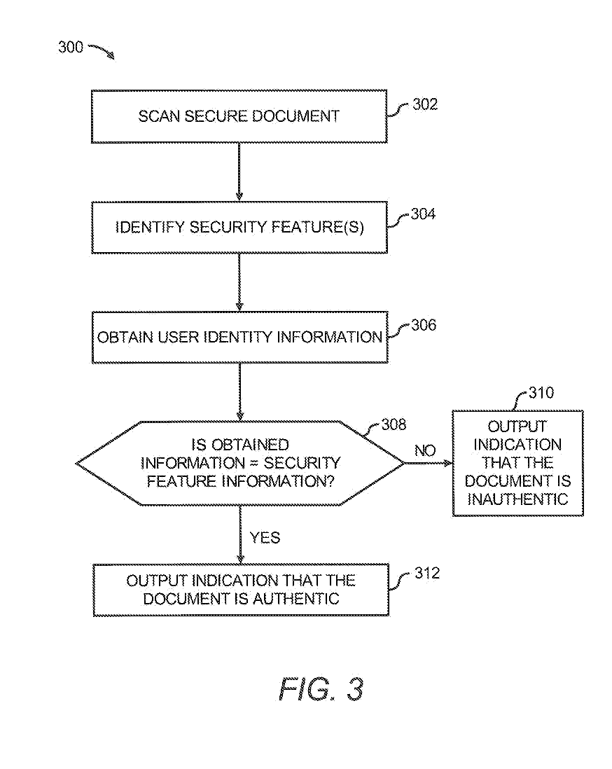

Turning now to FIG. 3, there is shown a flow diagram of a method 300 of verifying an authenticity of a secure document with a multi-function apparatus, according to an example. It should be apparent to those of ordinary skill in the art that the method 300 represents a generalized illustration and that other steps may be added or existing steps may be removed, modified or rearranged without departing from a scope of the method 300.

Generally speaking, the method 300 may be performed through use of a multi-function apparatus 100 other than multi-function apparatus 100, for instance, a multi-function apparatus 100 that is under the command of another user who wishes to authenticate a secure document created by a first user.

At step 302, the scanning module 120 receives a scanned image of the secure document. The scanned image may be obtained through implementation of one or both of the security feature scanning device 128 and the content scanning device 129. In any event, the scanned image includes the one or more security features that have been printed onto the document.

At step 304, the identity information converting module 116 converts the one or more security features that are contained in the scanned image into a form that enables comparison with user information. For instance, the identity information converting module 116 is configured to convert the one or more security features back to the original (or substantially back to the original) user identity information form. This conversion process may include a decryption operation if the security feature was originally encrypted. In addition, the converted form may also include information that indicates which type of user identity information was used to create the security feature(s).

As discussed above, at step 304, the multi-function apparatus 100 may access a server on which information pertaining to the security feature is stored, for instance, via the Internet. The identity information converting module 116 is configured to use the information to at least one of identify and access the data contained in the security feature.

At step 306, the identity information receiving module 112 receives user identity information, for instance, as indicated in the converted form of the security feature(s). By way of example, the identity information may comprise biometric information obtained from the user whose identity information was converted into the security feature. At step 308, the document verification module 122 determines whether the identity information obtained at step 306 substantially (or nearly identically) matches the information contained in the security feature(s).

If the document verification module 122 determines that the identity information obtained at step 306 is substantially or nearly equivalent to the security feature information, the document verification module 122 outputs an indication that the document is inauthentic, as indicated at step 310. If the document verification module 122 determines that the identity information obtained at step 306 is not substantially or nearly equivalent to the security feature information, the document verification module 122 outputs an indication that the document is authentic, as indicated at step 312.

In addition, although not shown, the document verification module 122 may also compare the one or more additional security features converted from the relevant information with the actual visibly printed relevant information to determine whether the visibly printed relevant information has been altered. If the document verification module 122 determines that the relevant information has been altered, the document verification module 122 may output an indication to this effect.

In addition, or alternatively, the document verification module 122 may notify the user of the presence of the one or more additional security features, particularly when the one or more additional security features are printed with nearly invisible ink, to thereby alert the user into verifying that the relevant information has not been altered.

Some or all of the operations set forth in the methods 200, 220, and 300 may be contained as one or more utilities, programs, or subprograms, in any desired computer accessible or readable medium. In addition, the methods 200, 220, 300 may be embodied by a computer program, which may exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

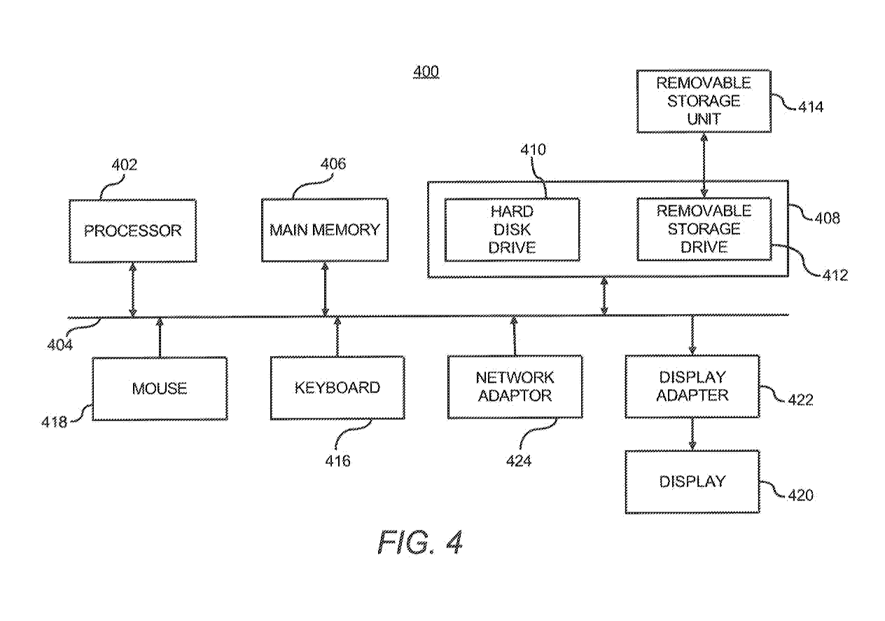

FIG. 4 illustrates a computer system 400, which may be employed to perform the various functions of the multi-function apparatus 100 described herein above, according to an example. In this respect, the computer system 400 may be used as a platform for executing one or more of the functions described hereinabove with respect to the processing component 110.

The computer system 400 includes a processor 402, which may be used to execute some or all of the functions of the controller discussed above. Commands and data from the processor 402 are communicated over a communication bus 404. The computer system 400 also includes a main memory 406, such as a random access memory (RAM), where the program code for, for instance, the processing component 110, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for creating a secure document.

The removable storage drive 412 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands. for the display 420. In addition, the processor 402 may communicate over a network, for instance, the Internet, LAN, etc., through a network adaptor 424.

It will be apparent to one of ordinary skill in the art that other known electronic components may be added or substituted in the computer system 400. In addition, the computer system 400 may include a system board or blade used in a rack in a data center, a conventional “white box” server or computing device, etc. Also, one or more of the components in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method of creating a secure document with a multi-function apparatus, said method comprising:
obtaining identity information of a user;
converting the identity information into a security feature, wherein the security feature is created to enable the user's identity information to be retrievable directly from the security feature; and
printing the security feature onto the document with the multi-function apparatus.

2. The method according to claim 1, wherein printing the security feature onto the document further comprises printing the document through use of a material that is nearly invisible to the naked eye.

3. The method according to claim 2, further comprising:
verifying an authenticity of the document by receiving user information and comparing the received user information with information contained in the security feature; and
outputting an indication that the document is authentic in response to the received user information being substantially similar to the information contained in the security feature.

4. The method according to claim 1, wherein obtaining the identity information of the user further comprises obtaining biometric information of the user and wherein converting the identity information further comprises converting the biometric information into the security feature.

5. The method according to claim 4, wherein obtaining the biometric information of the user further comprises obtaining at least one of a fingerprint, facial image, eye information, and voice information of the user.

6. The method according to claim 4, further comprising:
verifying an authenticity of the document by receiving biometric information of the user and comparing the received biometric information with information contained in the security feature; and
outputting an indication that the document is authentic in response to the received biometric information being substantially similar to the information contained in the security feature.

7. The method according to claim 1, wherein obtaining the identity information of the user further comprises obtaining authorization information of the user, wherein said authorization information enables identification of the user.

8. The method according to claim 7, further comprising:
determining whether the user is authorized to access the document based upon the authorization information; and
denying the user access to the document in response to a determination that the user is not authorized to access the document.

9. The method according to claim 1, wherein obtaining the identity information of the user further comprises obtaining a sequence of interactions between the user and the multi-function apparatus, and wherein converting the identity information into a security feature further comprises converting the sequence of interactions into the security feature.

10. The method according to claim 1, further comprising:
identifying at least one relevant information on the document;
printing the identified at least one relevant information on the document through use of a material that is nearly invisible to the naked eye.

11. A multi-function apparatus comprising:
an identity information receiving module configured to receive a user's identity information;
an identity information converting module configured to convert the user's identity information into a security feature, wherein the security feature is created to enable the user's identity information to be retrievable directly from the security feature; and
a printing module configured to print the security feature onto a document.

12. The multi-function apparatus according to claim 11, further comprising:
a security feature printing device, wherein the printing module is configured to implement the security feature printing device to print the security feature onto the document using a material that is nearly invisible to the naked eye.

13. The multi-function apparatus according to claim 12, further comprising:
a security feature scanning device configured to scan the document and capture the security feature that has been printed on the document with the nearly invisible material; and
a document verification module configured to verify an authenticity of a document containing the security feature based upon the security feature captured by the security feature scanning device.

14. The multi-function apparatus according to claim 11, further comprising:
an input source configured to receive the user's biometric information, wherein the identity information converting module is configured to convert the user's biometric information into the security feature.

15. A computer readable storage medium on which is embedded one or more computer programs, said one or more computer programs implementing a method of creating a secure document with a multi-function apparatus, said one or more computer programs comprising a set of instructions for:
obtaining identity information of a user;
converting the identity information into a security feature, wherein the security feature is created to enable the user's identity information to be retrievable directly from the security feature; and
printing the security feature onto the document with the multi-function apparatus.
